(19) United States
(12) Patent Application Publication
(10) Pub. No.: US 2026/0146487 A1
(43) Pub. Date: May 28, 2026

(54) ARRANGEMENT COMPRISING A DEVICE FOR GUIDING A SLIDING DOOR OF A MOTOR VEHICLE

(71) Applicant: RENAULT S.A.S., Boulogne Billancourt (FR)

(72) Inventors: Gregor HEWAK, Guyancourt (FR); Martin KRBEC, Plzen-Skvrnany (CZ)

(73) Assignee: RENAULT S.A.S., Boulogne Billancourt (FR)

(21) Appl. No.: 19/121,259

(22) PCT Filed: Oct. 18, 2023
(86) PCT No.: PCT/EP2023/079049

§ 371 Date: Apr. 15, 2025

(30) Foreign Application Priority Data
Oct. 20, 2022 (FR) FR2210850

(51) Int. Cl. E05D 15/10

(52) U.S. Cl. CPC E05D 15/101; E05Y 2900/531

(57) ABSTRACT

An arrangement for holding and guiding a sliding opening element relative to a body of a vehicle including a device for guiding the opening element including a rail and a movement structure that engages with the rail. The arrangement also includes a headliner trim element to be mounted on the vehicle and a movable headliner flap to be mounted pivotably relative to the trim element. The movable flap includes a guide element that runs parallel to the main direction and is able to engage with the movement structure so as to move the movable flap relative to the trim element and vary a degree of opening of the movable flap.

The invention relates to an arrangement comprising a device for guiding a sliding door of a vehicle. The invention also relates to a vehicle comprising such an arrangement. Finally, the invention relates to a method for operating such an arrangement.

In the automotive field, vehicles, particularly motor vehicles such as utility vehicles, vans or people carriers, can comprise at least one slidably mounted door. Such a door can be moved between a closed position, in which it obstructs an opening of the vehicle, and an open position, in which the door extends facing a side of the body of the vehicle in order to leave access to the opening clear. In order to allow such movement, the vehicle conventionally comprises a system for supporting and/or guiding the sliding door, comprising at least one upper guide positioned in the door opening near a roof, and a lower guide positioned in the door opening near a floor.

In the known solutions, the upper guides used are conventionally concealed by a frame of the door and placed inside the vehicle. As a result, the geometry of the upper guide has a considerable impact on the vehicle body architecture and gives rise to aesthetic and habitability constraints. In particular, the geometry of the conventional upper guides limits the roof slope and door frame options to small values, particularly of the order of 8°, and is unsuitable for vehicles having a significant roof slope, for example of the order of 25°.

The present invention aims to provide an arrangement comprising a device for guiding a sliding door that overcomes the drawbacks above and improves the prior art devices. The invention particularly makes it possible to produce a simple, reliable arrangement having a small footprint and making it possible to conceal an upper guide of a sliding door, in particular a door having rotating and translating kinematics, without distorting the headlining.

The invention relates to an arrangement for retaining and guiding a sliding door relative to a body of a vehicle, in particular a motor vehicle, comprising a device for guiding a sliding door comprising a rail extending along a main direction and movement means interacting with the rail so as to slide relative to it, characterized in that the arrangement further comprises:
a headlining trim element, configured to be mounted on the vehicle; and
a movable headlining flap, configured to be pivotably mounted relative to the trim element, the movable flap comprising a guide element extending parallel to the main direction and configured to interact with the movement means so as to move the movable flap relative to the trim element and vary a degree of opening of the movable flap.

The movement means can comprise a movable carriage, the movable carriage holding a guide member, such as a roller, configured to interact with the guide element of the movable flap.

The guide element can have a variation in dimension along at least one direction transverse, in particular orthogonal, to the main direction, so as to vary the degree of opening of the movable flap relative to the trim element.

In addition:
the guide element can be a rib or a groove; and/or
the guide element and at least one wall of the movable flap can be integrally formed, or the guide element can be applied to a wall of the movable flap; and/or
the movable flap can comprise members for reinforcing the guide element, extending transversely, in particular orthogonally, to the main direction.

The arrangement can further comprise an articulated arm connected to the movement means at a first end, and a connecting member held by a second end of the articulated arm, opposite the first end and configured to be connected to the sliding door, the movable flap comprising at least one recess and/or a slot configured to at least partially receive the articulated arm.

The movement means can be configured to be moved between an open end configuration and a closed end configuration, the arrangement further comprising at least one immobilizing means, in particular a spring, positioned on an end portion of the movable flap along the main direction and configured to retain the movable flap in the closed end configuration.

The arrangement can also comprise:
a body provided with an opening, in particular a side opening; and
a door sliding relative to the body, in particular a side door, the sliding door being capable of moving between a closed position in which the sliding door prevents access through the opening and an open position in which the sliding door is offset from the opening.

In particular, the arrangement can comprise at least one mechanism for guiding the sliding door, one of the guide device and the guide mechanism being configured to interact with an upper portion of the sliding door and the other of the guide device and the guide mechanism being configured to interact with a lower portion of said door, the arrangement further comprising means for driving one of the guide device and the guide mechanism.

The invention also relates to a vehicle, in particular a motor vehicle, comprising an arrangement according to the invention.

Finally, the invention relates to a method for operating an arrangement as set out above, comprising opening and/or closing the sliding door, moving the movement means relative to the rail, in particular in translation, and simultaneously moving the movement means relative to the guide element so as to move the movable flap relative to the trim element and vary a degree of opening of the movable flap.

Further details, features and advantages will become more clearly apparent upon reading the detailed description given below by way of non-limiting indication and with reference to the various exemplary embodiments illustrated in the following figures:

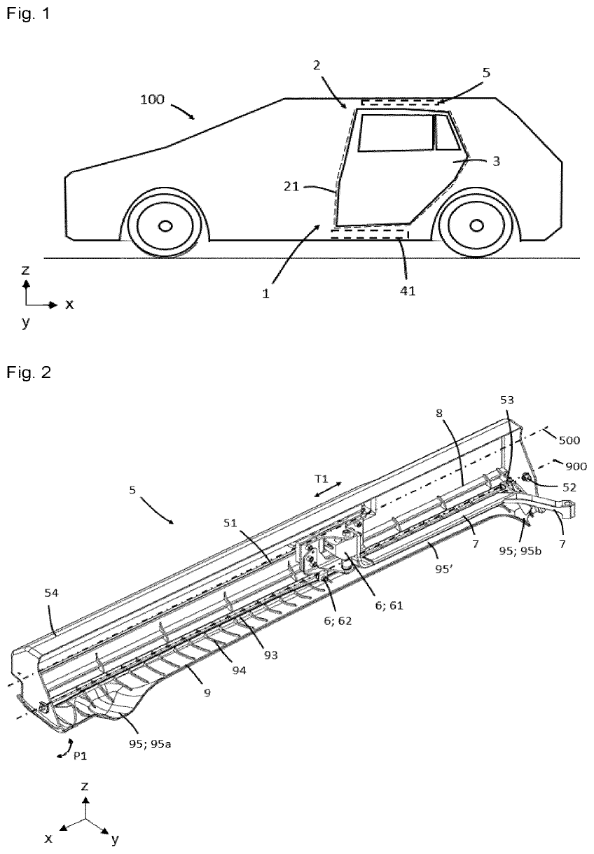

FIG. 1 is a simplified schematic depiction of an exemplary embodiment of a vehicle provided with an arrangement comprising a device for guiding a sliding door.

FIG. 2 is a schematic perspective depiction of one part of the arrangement.

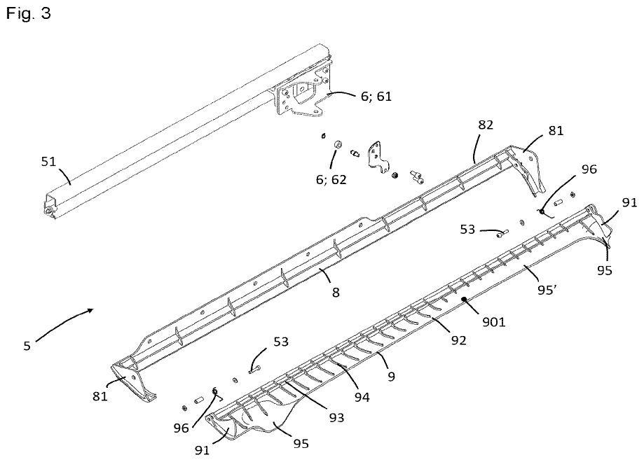

FIG. 3 is an exploded depiction of the part of the arrangement illustrated in FIG. 2.

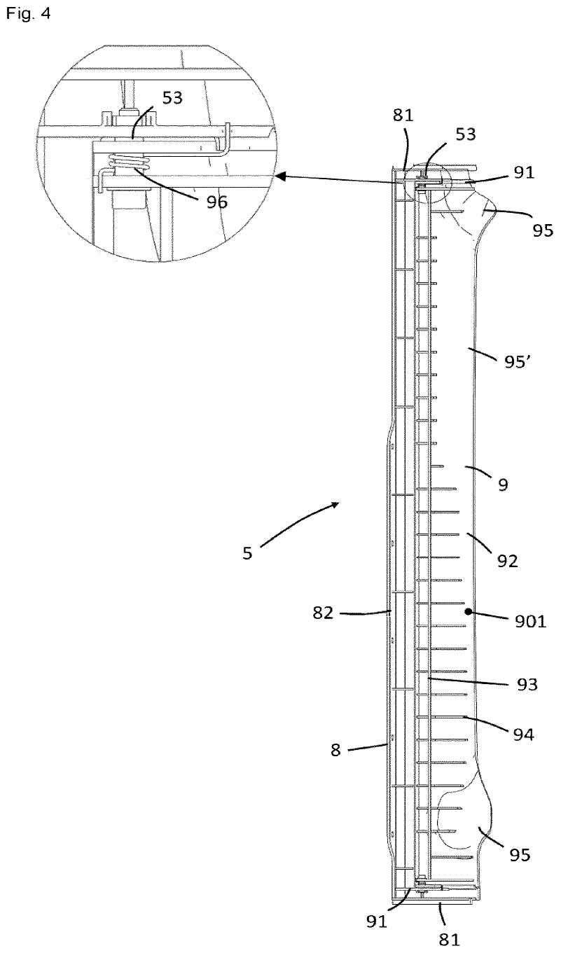

FIG. 4 is a simplified depiction of a trim element and a movable flap of the arrangement.

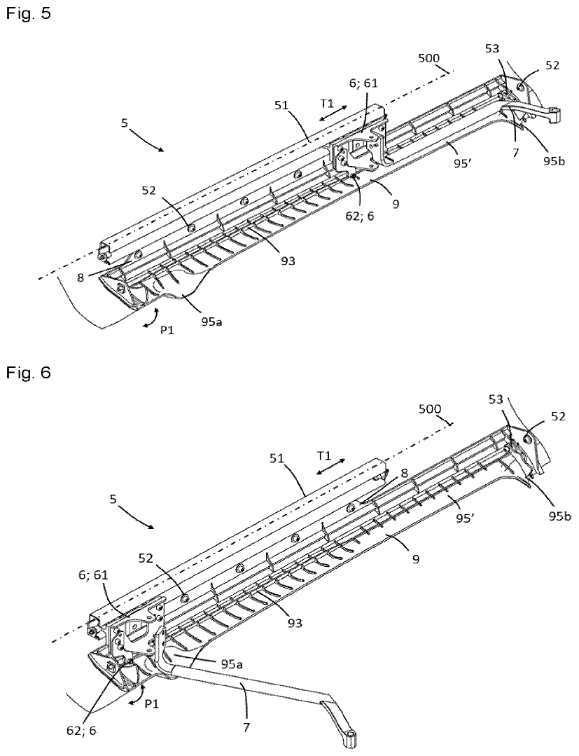

FIG. 5 is a schematic depiction of the arrangement in a first configuration.

FIG. 6 is a schematic depiction of the arrangement in a second configuration.

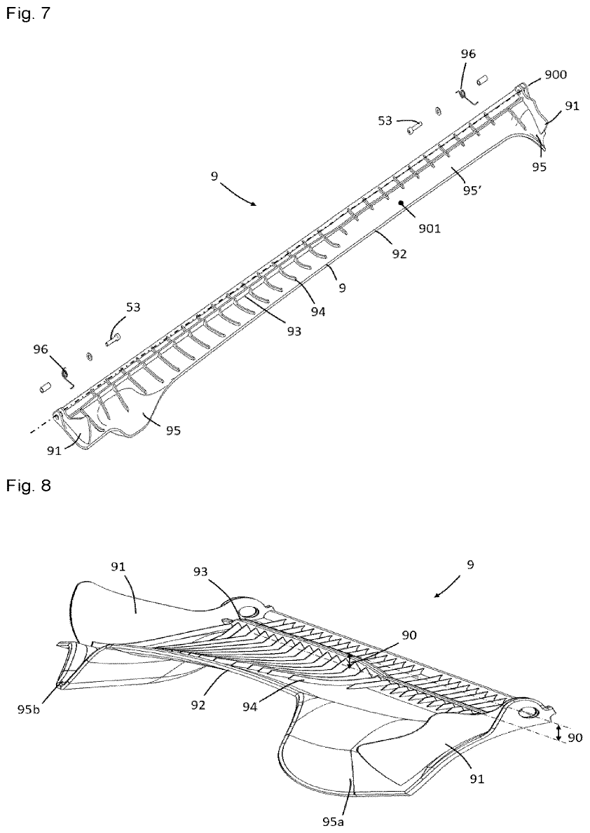

FIG. 7 is a schematic depiction of one exemplary embodiment of the movable flap.

FIG. 8 is a schematic depiction of one exemplary embodiment of the movable flap.

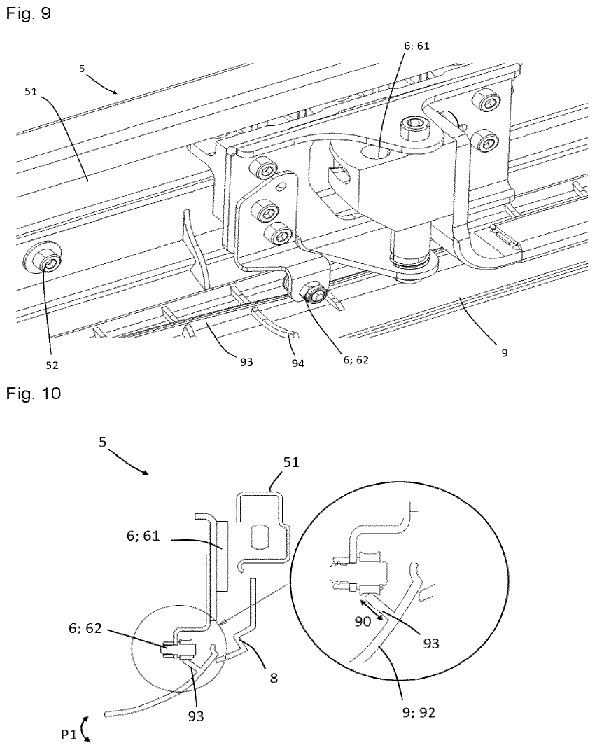

FIG. 9 is a simplified depiction of the interaction between movement means and the movable flap.

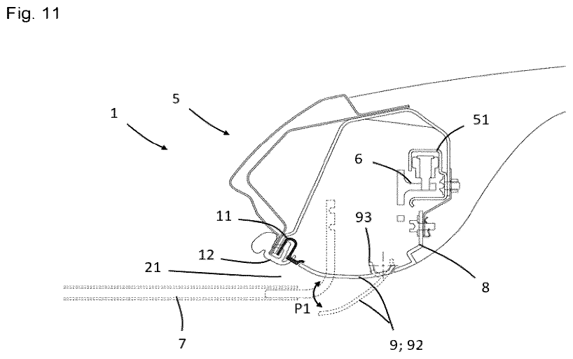

FIG. 10 is a simplified cross-sectional depiction of the interaction between the movement means and the movable flap illustrated in FIG. 9.

FIG. 11 is a simplified cross-sectional depiction of the arrangement.

FIG. 1 schematically illustrates an exemplary embodiment of a vehicle 100, in particular a motor vehicle. The vehicle 100 in question can, for example, be a passenger vehicle or a utility vehicle. Preferably, the vehicle 100 is a van or people carrier.

FIGS. 1 to 10 illustrate different examples and embodiments of the vehicle 100 according to the invention. By convention, in the description below, the direction in which the motor vehicle 100 travels in a straight line is defined as the longitudinal direction X. The direction perpendicular to the longitudinal direction and situated in a plane parallel to the ground is referred to as the transverse direction Y. The direction perpendicular to the directions X and Y is referred to as the vertical direction Z. A direct coordinate system XYZ, conventionally used in the automotive field, is thus defined. The terms “top” and “bottom” or “upper” and “lower” are used in their general sense, the terms “bottom” and “lower” denoting greater proximity to the ground. The same applies to the terms “front” and “rear”. Equally, the terms “first” and “second” are used to distinguish between similar elements, and not to define a hierarchy among said elements.

The vehicle 100 comprises an arrangement 1 for retaining and guiding a sliding door relative to a body 2 of the vehicle 100. The arrangement 1 can in particular comprise the body 2 of the vehicle 100, provided with an opening 21, and at least one sliding door 3 movably mounted relative to said body 2. “Sliding” is given to mean that the door is capable of being moved along a trajectory at least partially defined by a movement in translation. The door can particularly be moved in a helical movement, combining a movement in translation and at least one movement in rotation, as set out in greater detail below.

In this instance, the arrangement 1 illustrated is shown in a side opening 21 of the body 2, the door 3 in question being a rear side door. It will be understood that the door 3 can be arranged, non-limitingly, on the driver's side and/or the passenger side. Equally, the arrangement 1 can extend to a luggage compartment opening 21 and a luggage compartment door. Additionally, the vehicle 100 can comprise a plurality of sliding doors 3.

The door 3 is thus capable of being moved by sliding relative to the body 2 between a closed position in which the door 3 obstructs, for example fully, access through the opening 21, and an open position 21 in which the door 3 allows access, for example complete access to the opening 21, and by extension to a passenger compartment of the vehicle 100. As illustrated in FIGS. 1 and 2, preferably, the door 3 is moved in translation along an axis parallel or substantially parallel to the longitudinal direction X. It will be understood that the door 3 can also be moved to one or more intermediate positions, between the closed position and the open position, one intermediate position corresponding to an intermediate open position in which the door 3 is partially offset relative to the opening 21.

The arrangement 1 comprises in particular a device 5 for guiding the sliding door 3. The arrangement 1 can further comprise at least one mechanism 41 for guiding the sliding door 3. In particular, the guide device 5 and the guide mechanism 41 are configured to be positioned inside the vehicle 100, that is, in the passenger compartment of the vehicle 100. One of the guide device 5 and the guide mechanism 41 is configured to interact with an upper portion of the sliding door 3 and the other of the guide device 5 and the guide mechanism 41 is configured to interact with a lower portion of said door 3. The same applies to at least part of the body 2 surrounding the opening 21, in particular surrounding a frame defining the opening 21. The arrangement can further comprise means, not shown, for driving one of the guide device 5 and the guide mechanism 41. As a result, one of the guide device 5 and the guide mechanism 41 interacting with the drive means is the driving element, while the other is the driven element.

In this instance, and preferably, the guide device 5 is arranged on the body 2 in the upper region of the opening 21, while the guide mechanism 41 is positioned in the lower region of the opening 21, for example inside the hollow space of a sill zone. Also in the example illustrated, the lower guide mechanism 41 interacts with the drive means so that it is the driving element, while the guide device 5 according to the invention is the driven element. It will be understood that such a depiction is in no way limiting.

As illustrated, the guide device 5 comprises a rail 51, or guide, extending along a main direction 500. Preferably, the rail 51 is at least partially straight or substantially straight, or even essentially straight. Here, “essentially” is given to mean that at least 50% of a length of the rail 51, defined along the main direction 500, is straight. The rail 51 can in particular be configured to be directly or indirectly fastened to the structure of the body 2, for example by means of at least one fastening means 52 such as screws or a screw/nut assembly.

The guide device 5 also comprises movement means 6 interacting with the rail 51 so as to slide relative thereto. According to a preferred exemplary embodiment, the movement means 6 comprises a movable carriage 61. The movement means 6 are also configured to be directly or indirectly connected to the sliding door 3. In particular, the arrangement 1 can further comprise an articulated arm 7, or a connecting rod, connecting the movement means 6 to the door 3 so as to transmit a movement of the door 3 to the guide device 5, or vice versa, depending on whether the guide device 5 is the driven or driving element respectively. For example, an assembly comprising the movable carriage 61 and a shuttle can be provided with sliding elements such as roller bearings, shaft clamps, Teflon pads or any other sliding element known to a person skilled in the art. Preferably, these sliding elements are made from a material having a low coefficient of friction allowing sliding that is non-destructive over time.

For example, the articulated arm 7 is connected to the movement means 6 at a first end. The articulated arm comprises in particular a pin 71 configured to be connected to the movement means 6 so that the arm is pivotably mounted about an axis of rotation, in particular orthogonal to the main direction 500, relative to the movement means 6. The articulated arm 7 comprises at least one articulation. A second end of the articulated arm 7, opposite to the first end, can be connected to the door 3 directly or by means of a connecting member, not shown, for example held by the door 3.

The movement means 6 are thus configured to be moved along all or part of the length of the rail 51, between a rear end position, corresponding for example to a position of the movement means 6 on the rail in which the door 3 that is connected thereto is placed in its open position, and a rear end position, corresponding for example to a position of the movement means on the rail in which the door 3 that is connected thereto is placed in its closed position. It will be noted that the end positions of the movement means 6 relative to the rail 51 are representative of an end of the travel, that is of the movement, of the movement means 6. These positions can be arranged at one end of the rail 51 along the length thereof or can have an intermediate position, as illustrated in FIG. 5 with respect to the closed end configuration. It will be understood that the end positions defining the travel of the movement means 6 illustrated are in no way limiting and can be reversed or modified without departing from the scope of the invention.

The arrangement 1 further comprises a headlining trim element 8, configured to be mounted on the vehicle 100, and a movable headlining flap 9, configured to be pivotably mounted relative to the trim element 8.

The trim element 8 is configured to be mounted in the vehicle 100, in particular on the body 2 of the vehicle 100. The trim element 8 is also configured to interact with the rail 51, in particular in order to receive said rail 51 so as to at least partially conceal it from the view of an occupant of the vehicle 100. The trim element 8 has an elongate structure that at least partially complements the shape of the rail 51. For example, when the arrangement 1 is assembled, the trim element 8 can extend along the main direction 500. The trim element 8 can thus be at least partially straight. In particular, non-limitingly, the trim element 8 comprises two end flanks 81 defining the trim element 8 along the main direction 500. The trim element 8 illustrated also comprises at least one side flank 82, connecting the end flanks 81 to each other. The trim element 8 is open on at least one side so as to receive the rail 51 and allow the movement of the movable flap 9. The trim element 8 can be mounted in the vehicle 100 by means of at least one of the flanks. In this regard, the side flank 82 and/or at least one of the end flanks 81 can for example comprise an orifice capable of receiving fastening means 52 as set out above.

Optionally, as illustrated in FIG. 2, the arrangement 1 can further comprise a trim housing 54. The housing 54 and the trim element 8 can be two separate parts, fixedly mounted relative to each other. Alternatively, as illustrated, the trim element 8 and the housing 54 can be a common part, for example integrally formed, in order to simplify the mounting of the arrangement 1. In this regard, the features relating to the trim element 8 can apply mutatis mutandis to the housing 54. In particular, at least one part of the arrangement 1, for example in the region of the guide device 5, can be fastened in the vehicle by means of at least one fastening means 52 on the housing 54 and/or the trim element 8.

The movable flap 9 is pivotably mounted relative to the trim element 8. The movable flap 9 comprises two end walls 91, each configured to extend facing one of the end flanks 81 of the trim element 8 when the arrangement 1 is assembled, and at least one intermediate wall 92, connecting the end walls 91 to each other. In order to allow the pivoting movement of the movable flap 9, the arrangement 1 comprises connecting means 53 forming a pivot connection centered on a pivot axis 900 of the movable flap 9. The pivot axis 900 particularly extends parallel or substantially parallel to the main direction 500. According to certain embodiments, the end flanks 81 and the end walls 91 can comprise a hole capable of receiving a pin and/or a screw, as illustrated, centered on a pivot axis 900 of the movable flap 9. Alternatively, the end flanks 81 and the end walls 91 can comprise complementary male and female connecting means 53.

The movable flap 9 according to the invention advantageously comprises a guide element 93 extending parallel to the main direction 500. The guide element 93 is positioned so that, when the movement means 6 are moved along the rail 51, they are configured to interact with the guide element 93 so as to pivot the movable flap 9 about the pivot axis 900, that is, and in particular, so as to vary a degree of opening of the movable flap 9 relative to the trim element 8.

Preferably, the movement means 6, in particular the movable carriage 61, comprises a guide member 62 configured to interact with the guide element 93 of the movable flap 9 when the arrangement 1 is assembled. In particular, according to one exemplary embodiment, the guide member 62 is a roller. The shapes and materials of the guide member 62 and the guide element 93 can be complementary so as to ensure the longevity of the arrangement 1.

The guide member 62 can be held, in the movement means 6, by a clevis or a stud, for example applied. For example, such a clevis or stud can be mounted on the carriage 61 of the movement means 6. The guide member 62 has an offset position relative to the rail 51 and/or the carriage 61 along at least one direction. In this instance, the guide member 62 has an offset position relative to the rail 51 and/or the carriage 61 along the vertical direction Z and along the transverse direction Y. The guide member 62 thus extends facing the guide element 93 along at least one direction. In the example illustrated, the roller of the guide member 62 thus rolls against an upper surface of the guide element 93 simultaneously with the movement of the movement means 6 along the rail 51.

FIGS. 2 to 8 illustrate different non-limiting exemplary embodiments of the guide element 93 and the interaction between said guide element 93 and the guide member 62.

Preferably, the guide element 93 is a rib or a groove. In this instance, in the examples illustrated, the guide element 93 is a rib extending protruding from an inner surface 901 of the movable flap 9, here facing toward a ceiling of the vehicle 100, in particular facing in the direction of the movement means 6. In this instance, the guide element 93 extends protruding from the intermediate wall 92.

The movable flap 9 can be made from a plastic material or a metal material, such as polypropylene, polymethyl methacrylate, also known as PMMA, or any derivative of biological materials. According to one exemplary embodiment, the guide element 93 and at least one of the walls of the movable flap 9 are integrally formed, that is, they form a one-piece assembly. “Integrally formed” is given to mean that they cannot be separated from each other without resulting in damage to the movable flap 9. In this instance, at least the intermediate wall 92 and the guide element 93 are integrally formed. Alternatively, the guide element 93 can be applied to one of the walls of the movable flap 9 and fastened, for example by gluing or using any other fastening means 52 known to a person skilled in the art. The guide element 93 and the flap can then be made from different materials. Optionally, the guide element 93 can comprise an applied or other metal part, in particular an insert, configured to limit any wear resulting from interaction with the movement means 6. Optionally, the guide element 93 can be removable.

Advantageously, the guide element 93 can have a variation of a dimension 90 measured along at least one direction transverse, in particular orthogonal, to the main direction 500, relative to the inner surface 901 of the movable flap 9 so as to vary the degree of opening of the movable flap 9 relative to the trim element 8. “Variation of a dimension” is in particular given to mean a variation of a height of the rib of the guide element 93, as illustrated in FIG. 8. Alternatively, according to an exemplary embodiment not shown, the “variation in dimension” can be representative of a variation in the depth of a groove of the guide element 93.

As a result, when the movement means 6 moves along the trajectory defined by the rail 51, the guide member 62, here the roller, moves concomitantly along the guide element 93, here the rib. The movement means 6 moves without any variation in height relative to the rail 51. However, the movable flap 9 moves about the pivot axis 900 as a function of the interaction between the guide element 93 and the guide member 62.

In the example illustrated, the greater the height of the guide element 93, the more the guide member 62 lowers the movable flap 9. In other words, the intermediate wall 92, particularly an edge of the intermediate wall 92 furthest from the rail 51 and/or the trim element 8, will be pivoted and lowered to a greater extent. The degree of opening of the flap relative to the trim element 8 will therefore be greater. Conversely, when the height of the guide element 93 is low, the guide member 62 lowers the movable flap 9 a little or not at all depending on the desired adjustment. The intermediate wall 92 then pivots slightly, or not at all, relative to the rail 51 and/or the trim element 8. The degree of opening of the movable flap 9 relative to the trim element 8 thus varies between a “nominal” or “closed” configuration in which the movable flap 9 is not moved, here obtained at a lowest, or low, height of the guide element 93, and a “tilted” or “open” configuration obtained at a highest, or high, height of the guide element 93. An exemplary embodiment of the movable flap 9 in the “nominal” configuration is shown in solid lines in FIG. 11, while the movable flap 9 pivoted to the “tilted” configuration is illustrated in dashed lines in the same figure. Such a variation in the degree of opening of the movable flap 9 particularly allows the passage of the articulated arm 7 when the door is moved between its “closed” position and its “open” position. In particular, such a variation is configured to be adapted to an architecture of the door, in particular a shape of the opening 21 and/or a roof slope.

The movable flap 9 can also be moved into one or more intermediate configuration(s), obtained when a point of the guide element 93 interacting with the movement means 6 selected along the length thereof has a height between the lowest height and the highest height relative to the inner surface 901 of the movable flap 9. The reverse principle applies mutatis mutandis to a guide element 93 comprising a groove.

Optionally, as illustrated in FIG. 11, the arrangement 1 according to the invention can also comprise a sealing and/or damping member 11, such as a seal, configured to interact with a free end of the movable flap 9. The sealing and/or damping member 11 can for example be fastened to or in the vicinity of the opening 21 of the body 2. For example, it can be held by a clip 12 holding a door frame seal lining the opening 21.

Optionally, the movable flap 9 can comprise members 94 for reinforcing the guide element 93. The reinforcing members 94 can be distributed along all or part of the length of the guide element 93. The reinforcing members 94 extend transversely, in particular orthogonally, to the guide element 93 and the main direction 500. Advantageously, when the guide element is removable and/or applied, the reinforcing members 94 also have the function of retaining the guide element 93.

Optionally but preferably, the movable flap 9 can comprise at least one recess 95 and/or at least one slot 95′ configured to at least partially receive the articulated arm 7. The recess 95 can in particular be configured so as to receive the articulated arm 7 when, connected to the movement means 6, it is in at least one of the front or rear end positions described above along the rail 51, corresponding to the open or closed position of the sliding door 3 relative to the body 2.

In the example illustrated, the intermediate wall 92 of the movable flap 9 comprises a first recess 95a, configured to receive the articulated arm 7 when the door 3 is placed in the open position. The intermediate wall 92 of the movable flap 9 also comprises a second recess 95b, situated at the opposite end from the first recess 95a along the main direction 500 and the rail 51, configured to receive the articulated arm 7 when the door 3 is placed in the closed position. The depth of the recess 95 in question can depend on the variation of the dimension 90 in question of the guide element 93 as set out above; for example, the greater the dimension 90 in question, the shallower the depth of the recess 95, and vice versa. Alternatively, the recess 95 can be replaced by a cut-out defining a slot 95′ capable of at least partially receiving the articulated arm 7. The movable flap 9 illustrated also shows an alternative example of a slot 95′ capable of receiving the arm, in which the reinforcing members 94 are arranged so as to allow the positioning of part of the articulated arm 7 parallel, or substantially parallel, to the guide element 93 and/or the rail 51 in one of the aforementioned positions.

Optionally but preferably, the arrangement 1 further comprises at least one immobilizing means 96 positioned on an end portion, along the main direction 500, of the movable flap 9, configured to retain the movable flap 9 in the closed end configuration. In particular, the immobilizing means 96 can be one or more springs. In the example illustrated, a spring is positioned on the opposite end portions of the movable flap 9 so that it extends between one of the end flanks 81 of the trim element 8 and one of the end walls 91 of the movable flap 9. The immobilizing means 96 make it possible to return the movable flap 9 to the “nominal” or “closed” configuration when the guide member 62 does not lower the guide element 93.

The invention also extends to a method for operating the arrangement 1 according to the invention. Such a method can also be likened to a method for using the arrangement 1 or a vehicle 100 provided with an arrangement 1 according to the invention.

The method comprises opening 21 and/or closing the sliding door 3 and moving the movement means 6 relative to the rail 51. In the example illustrated, when the door 3 is open or closed, the articulated arm 7 connected to the door 3 is driven, and the same applies to the movement means 6 connected to said arm. As set out above, the movement means 6 can in particular move in translation T1. The method also comprises the simultaneous movement of the movement means 6, in particular by means of the guide member 62 such as at least one roller, relative to the guide element 93, so as to move the movable flap 9 relative to the trim element 8 and vary a degree of opening of the movable flap 9. The trajectory of the guide member 62 is parallel, or substantially parallel, to the trajectory defined by the rail 51, and it is the interaction of the movement means 6 with the guide element 93, by means of the guide member 62, that allows the movement of the movable flap 9, in particular the pivoting P1 of the flap about the pivot axis 900, as described above.

The present invention thus proposes an arrangement comprising a device for guiding a sliding door of a motor vehicle advantageously making it possible to conceal the operation of said device, in particular of the rail allowing the movement of the door. The aesthetics of the motor vehicle, and in particular the aesthetics of the body side, are thus optimized. In particular, when the door is closed, the rail is invisible and covered by the movable flap of the device.

The invention is advantageously suitable for a wide variety of vehicles provided with at least one sliding door, such as for example heavy duty vehicles, buses, trains, or even aircraft, and for a wide variety of sliding door, in particular roof slope, architectures, limiting the intrusion of the device. For example, the invention is suitable for door openings of different sizes. The invention also makes it possible to use conventional rails, in particular straight rails, fitting perfectly into a conventional body side geometry. The arrangement, in particular the guide device, can easily be incorporated inside the vehicle, in the passenger compartment, for example behind a side roof rail trim, so that it makes it possible to retain a door with a frame and a desired roof slope while limiting the intrusion of the device.

The present invention is not however limited to the means and embodiments described and illustrated herein, and also extends to any equivalent means or embodiments and to any technically functional combination of such means provided that they ultimately perform the functions described and illustrated in the present document.

1-10. (canceled)

11. An arrangement for retaining and guiding a sliding door relative to a body of a vehicle, comprising:
a device for guiding a sliding door comprising a rail extending along a main direction and movement means interacting with the rail so as to slide relative to the rail;
a headlining trim element configured to be mounted on the vehicle; and
a movable headlining flap configured to be pivotably mounted relative to the trim element, the movable flap comprising a guide element extending parallel to the main direction and configured to interact with the movement means so as to move the movable flap relative to the trim element and vary a degree of opening of the movable flap.

12. The arrangement as claimed in claim 11, in which the movement means comprise a movable carriage, the movable carriage holding a guide member, configured to interact with the guide element of the movable flap.

13. The arrangement as claimed in claim 12, in which the guide member is a roller.

14. The arrangement as claimed in claim 11, in which the guide element has a variation in dimension along at least one direction transverse to the main direction so as to vary the degree of opening of the movable flap relative to the trim element.

15. The arrangement as claimed in claim 14, in which the at least one direction is orthogonal to the main direction.

16. The arrangement as claimed in claim 11, in which the guide element is a rib or a groove.

17. The arrangement as claimed in claim 11, in which the guide element and at least one wall of the movable flap are integrally formed, or the guide element is applied to a wall of the movable flap.

18. The arrangement as claimed in claim 11, in which the movable flap comprises members for reinforcing the guide element extending transversely to the main direction.

19. The arrangement as claimed in claim 18, in which the guide element extends orthogonally to the main direction.

20. The arrangement as claimed in claim 11, further comprising an articulated arm connected to the movement means at a first end, and a connecting member held by a second end of the articulated arm, opposite the first end and configured to be connected to the sliding door, the movable flap comprising at least one recess and/or a slot configured to at least partially receive the articulated arm.

21. The arrangement as claimed in claim 20, in which the movement means are configured to be moved between an open end configuration and a closed end configuration, the arrangement further comprising at least one immobilizing means positioned on an end portion of the movable flap along the main direction and configured to retain the movable flap in the closed end configuration.

22. The arrangement as claimed in claim 21, in which the at least one immobilizing means is a spring.

23. The arrangement as claimed in claim 11, further comprising:
a body provided with an opening; and
a door sliding relative to the body, the sliding door being configured to move between a closed position in which the sliding door prevents access through the opening and an open position in which the sliding door is offset from the opening.

24. The arrangement as claimed in claim 23, in which the opening in the body is a side opening.

25. The arrangement as claimed in claim 23, in which the door sliding relative to the body is a side door.

26. The arrangement as claimed in claim 23, further comprising at least one mechanism for guiding the sliding door, one of the guide device and the guide mechanism being configured to interact with an upper portion of the sliding door and the other of the guide device and the guide mechanism being configured to interact with a lower portion of said door, the arrangement further comprising means for driving one of the guide device and the guide mechanism.

27. A vehicle, comprising:
the arrangement as claimed in claim 11.

28. A method for operating the arrangement as claimed in claim 23, comprising:
opening and/or closing the sliding door; and
moving the movement means relative to the rail and simultaneously moving the movement means relative to the guide element so as to move the movable flap relative to the trim element and vary a degree of opening of the movable flap.
